(19) United States
(12) Patent Application Publication
(10) Pub. No.: US 2016/0345537 A1
(43) Pub. Date: Dec. 1, 2016

(54) ARRANGEMENT APPLIED IN ANIMAL CAGE

(71) Applicant: ALESCO INDÚSTRIA E COMÉRCIO LTDA., Monte Mor (BR)

(72) Inventor: Nelson Aparecido Tonin, Sao Paulo (BR)

(21) Appl. No.: 14/871,396

(22) Filed: Sep. 30, 2015

(30) Foreign Application Priority Data
May 25, 2015 (BR) 20 2015 011941 6

(51) Int. Cl. A01K 1/00; F24F 7/013; F24F 7/06; F24F 13/02; F24F 13/28

(52) U.S. Cl. CPC A01K 1/0058; F24F 13/0218; F24F 13/28; F24F 7/065; F24F 7/013; F24F 2007/001

(57) ABSTRACT

Arrangement Applied In Animal Cage, belonging to the technical veterinarian field, more particularly, it is a cage with active ventilation to animals such as rodents, rats, mice, and hamsters, for home use or in laboratory facilities, through which are achieved very advantageous practical, safe and functional results. The animal cage, made of polycarbonate, includes a cage, in the shape of a parallelepiped box, equipped, on the top perimeter, with flaps, with rounded edges, on which engages the lid with filter and on the rear face is provided a hole for coupling the exhaust system connected to a power source.

### CROSS-REFERENCE TO RELATED APPLICATIONS

The present application claims the priority benefit of Brazilian application number BR 20 2015 011941 6 filed May 25, 2015 and entitled “Arrangement Applied in Animal Cage,” the disclosure of which is hereby incorporated by reference.

### BACKGROUND

Field of Invention

This patent application refers to a new arrangement applied in an animal cage belonging to the technical veterinarian field. More particularly, it refers to a cage with active ventilation to animals such as rodents, rats, mice, and hamsters, for home use or in laboratory facilities, through which are achieved very advantageous practical, safe and functional results.

Description of the Related Art

Some cage models are known, from the state of the art, with passive ventilation and no effective air exchange for the animals that are inside of it. Such as the brands Braganca (see FIG. 6) and Critter Trail (see FIG. 7), but these models, because they are manufactured with wires and side vents, allow the escape of ammonia, allergens, dust and stench at the room/environment (house, apartment, etc.).

Some models of cages with active ventilation are known as well. These models are commonly found in laboratory facilities and research centers (see FIG. 8). In such cases, the cage is coupled to a ventilated rack (another equipment). In these racks are attached, at least, 30 cages that are ventilated by an electrical panel coupled with the rack, which perform the air exchange inside of each cage. These models of equipment are known as IVC (Individually Ventilated Caging). However, these cages present certain drawbacks, such as the restriction of the use in laboratory facilities, once they are attached in a ventilation system, which is coupled in specific racks. Thus, the equipment have a high cost, large volume and complexity of the ventilation system, therefore, it is not viable for domestic use. The cages do not work decoupled from the ventilated rack, so they do not have autonomy.

Thus, the new animal cage was developed, allowing its use at laboratory facilities and households, which consists of a closed cage, with top filter on the lid, and air exhauster on the back, in order to exhaust the air that is inside of the cage, together with the ammonia and the stench caused by it. This generates a negative pressure inside the cage and consequently, air exchange.

### SUMMARY OF THE CLAIMED INVENTION

In a first claimed embodiment, a cage system includes a cage having at least one air inlet opening and at least one air outlet opening. The cage system includes an air exhauster coupled to the air outlet opening of the cage. The air exhauster exhausts air from within the cage and creates a negative pressure that draws air into the cage through the air inlet opening when the air exhauster is coupled to a power source.

In a second claimed embodiment, a cage system includes a cage having a cage body and a lid coupled to the cage body. The lid includes at least one air inlet opening. The cage body includes at least one air outlet opening. The cage system further includes an air exhauster coupled to the air outlet opening of the cage body. The air exhauster exhausts air from within the cage and creates a negative pressure that draws air into the cage through the air inlet opening of the lid when the air exhauster is coupled to a power source.

In a third claimed embodiment, a cage system includes a cage having a cage body and a lid coupled to the cage body. The lid includes at least one air inlet opening and the cage body includes at least one air outlet opening. The cage system includes an exhaust system coupled to the cage. The exhaust system includes an air exhauster coupled to the air outlet opening of the cage body and a filter coupled to the air inlet opening of the lid. The air exhauster exhausts air from within the cage and creates a negative pressure that draws air into the cage through the air inlet opening and filter of the lid when the air exhauster is coupled to a power source.

### BRIEF DESCRIPTION OF THE DRAWINGS

FIG. 1—exploded perspective view of the new Arrangement Applied In Animal Cage;

FIG. 2—perspective view of the animal cage pointing out the rear, top and side faces;

FIG. 3—perspective view of the animal cage pointing out the frontal, side and top faces;

FIG. 4—side view of the animal cage;

FIG. 5—schematic side view of the cage with an outlet air duct going through a window;

FIG. 6—perspective view of the cage, from the state of the art, of the brand Braganca;

FIG. 7—perspective view of the cage, from the state of the art, of the brand Critter Trail; and

FIG. 8—perspective view of the laboratory rack with the cages attached on it.

### DETAILED DESCRIPTION

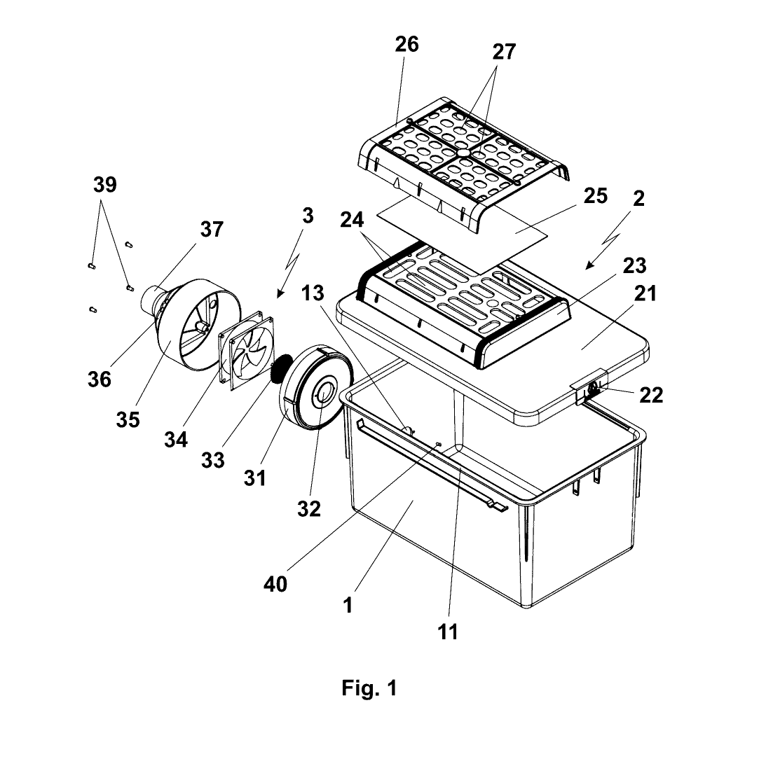

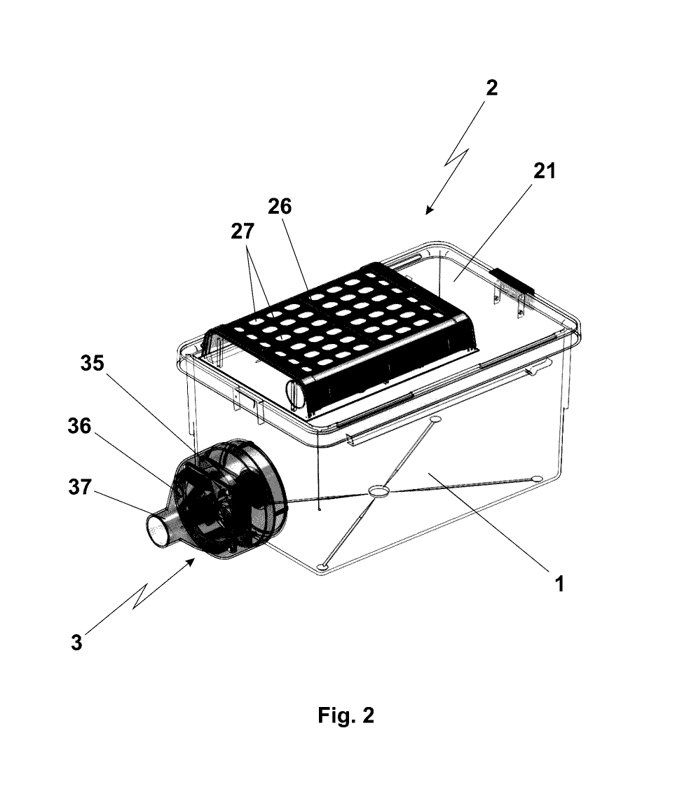

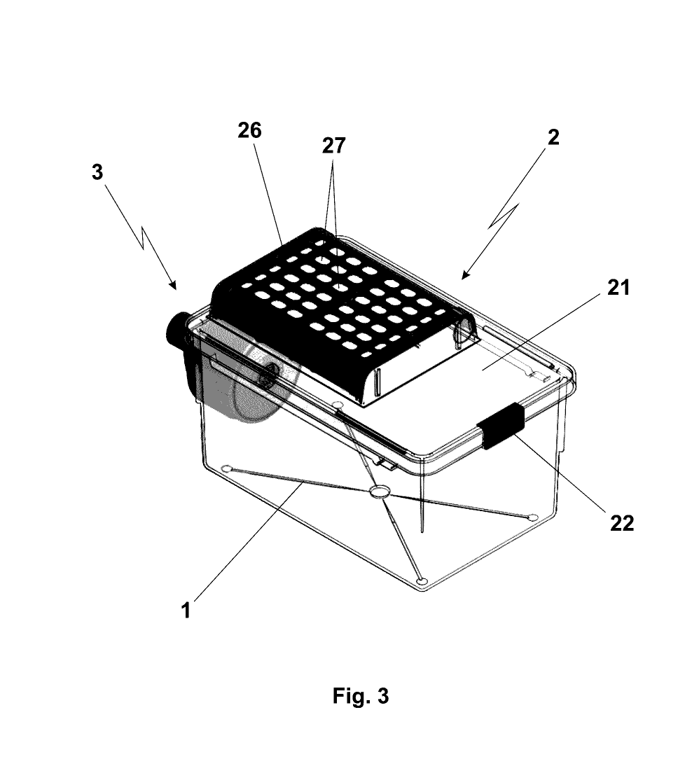

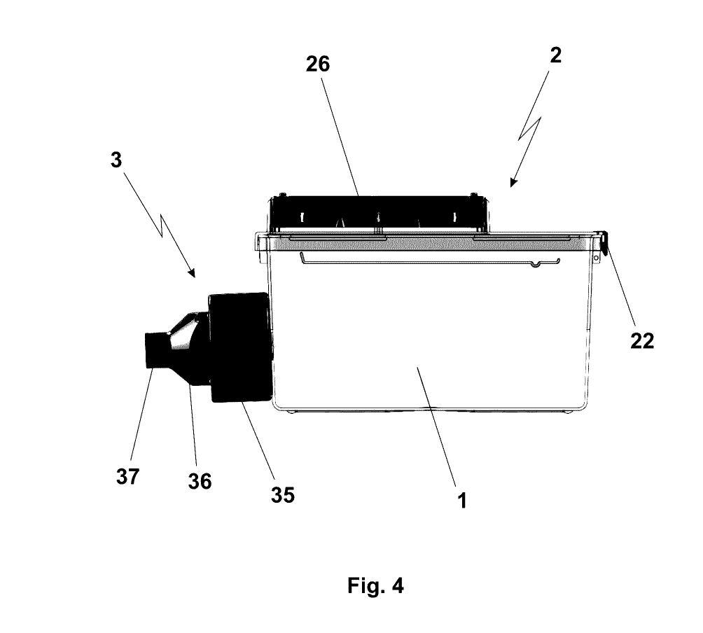

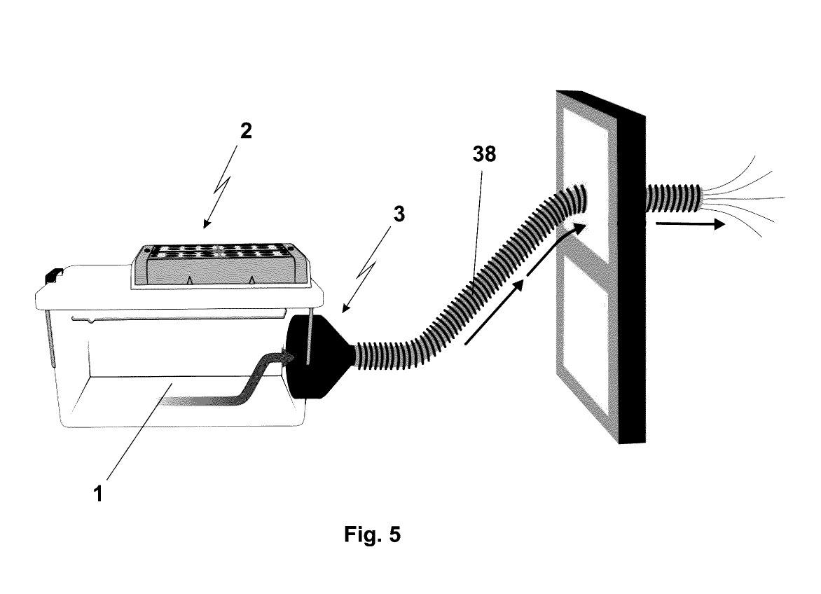

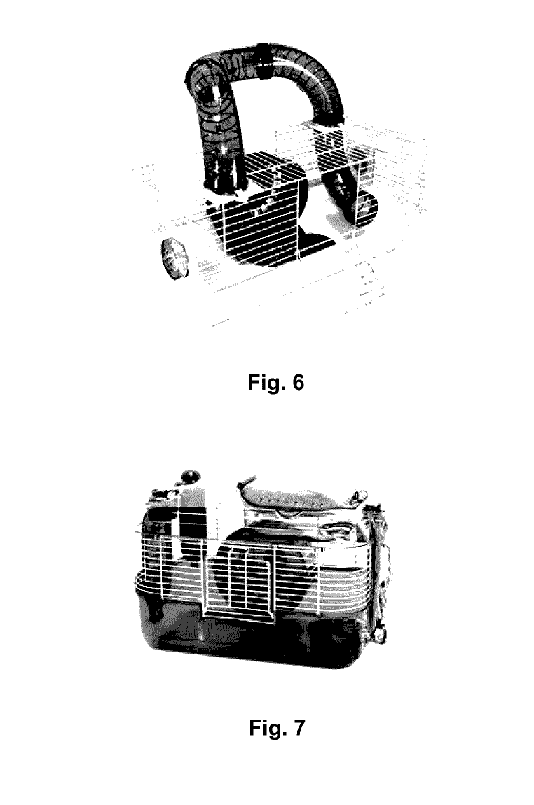

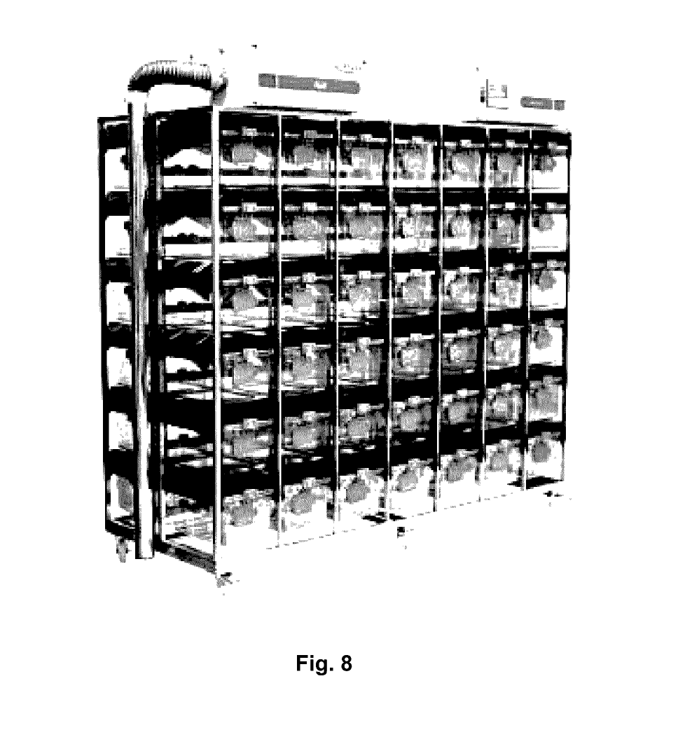

According to FIGS. 1 to 5, the new Arrangement Applied In Animal Cage, made of polycarbonate, includes a cage (1), in the shape of a parallelepiped box. Equipped, on the top perimeter, with flaps (11), with rounded edges, on which engages the lid (2) and on the rear face is provided a hole (13) for coupling the exhaust system (3) connected to a power source (power grid or battery).

The lid (2) has a rectangular body (21), with rounded edges. Being provided, on the front face, a locker (22) and a handle region, and on the top is provided a rectangular protrusion (23), endowed with openings (24) on which is placed the filter (25) that is fixed by the filter's support (26) rectangular with larger rounded sides. On the top are provided, as well, openings (27) that allow the air inlet.

The exhauster system (3) includes an annular support (31), which has, on the front face, an orifice (32) coincident with the orifice (13), internally receives a circular protective screen (33) to avoid the contact between the animal and the air exhauster (34). Also provided, the set is closed by pressure by the annular body (35), ending in a conical trunk (36) region, which ends in the tubular protrusion (37) fitting the air duct outlet (38) that directs the air to out of the room. The exhauster system (3) is fixed on the cage (1) by screws (40) and the air exhauster (34) is fixed on the annular body (35) by screws (39).

With the new Arrangement Applied In Animal Cage, its assembly, its disassembly and its utilization become extremely easy, mounting the filter lid (2), the exhauster system (3), and fixing them to the body (1) using locks (22) and screws (40) respectively. Then, simply connect the exhauster to a power source, and it will exhaust the air that is inside the cage, creating a negative pressure inside the cage, and consequently sucking the air from the openings (27), making the air exchange in the cage.

The new Arrangement Applied In Animal Cage, thus conceived, offers the following advantages over their counterparts (which are known until today):
Decrease contact with allergens for people living with the animal;
Drag ammonia out of the cage, reducing the risk of lung diseases for the animal;
Eliminate the bad smell, which is caused by accumulation of ammonia;
Do not allow the escape of sawdust and hair from the cage to the environment;
Easy handling;
Low cost;
Allows domestic application (with an exhauster system that eliminates ammonia, allergens, dust and bad smell from the cage), and
Enables portability of the object.

The coverage of the present cannot be limited to constructive details, but indeed, only to the defined terms in claim and equivalents.

What is claimed is:

1. A cage system, the system comprising:
a cage having at least one air inlet opening and at least one air outlet opening; and
an air exhauster coupled to the air outlet opening of the cage, the air exhauster exhausting air from within the cage and creating a negative pressure that draws air into the cage through the air inlet opening when the air exhauster is coupled to a power source.

2. The cage system of claim 1, wherein the cage includes a cage body and a lid.

3. The cage system of claim 2, wherein a top perimeter of the cage body includes a plurality of flaps to which the lid is coupled.

4. The cage system of claim 2, wherein the air inlet opening is disposed in the lid.

5. The cage system of claim 4, wherein the lid includes a filter disposed between the air inlet opening and a filter support, the filter support having at least one air inlet opening.

6. The cage system of claim 2, wherein the air outlet opening is disposed on a rear face of the cage body.

7. The cage system of claim 2, wherein the cage includes a locker region on a front face of the cage body.

8. The cage system of claim 1, wherein the air exhauster is coupled between an annular body and an annular support.

9. The cage system of claim 1, wherein the air exhauster couples to an air duct and the air exhauster exhausts air from within the cage into the air duct when the air exhauster is coupled to a power source.

10. The cage system of claim 8, wherein the annular body includes a conical trunk region, the conical trunk region having a tubular protrusion that couples to an air duct.

11. The cage system of claim 8, wherein the annular support includes an orifice and a screen disposed within the orifice, the orifice coincident with the air outlet opening disposed in the cage body.

12. The cage system of claim 1, wherein the cage is composed at least partially of polycarbonate.

13. A cage system, the system comprising:
a cage having a cage body and a lid coupled to the cage body, the lid including at least one air inlet opening and the cage body including at least one air outlet opening; and
an air exhauster coupled to the air outlet opening of the cage body, the air exhauster exhausting air from within the cage and creating a negative pressure that draws air into the cage through the air inlet opening of the lid when the air exhauster is coupled to a power source.

14. The cage system of claim 13, wherein the lid includes a filter disposed between the air inlet opening and a filter support.

15. The cage system of claim 14, wherein the filter support includes at least one air inlet opening.

16. The cage system of claim 13, wherein the air exhauster is coupled between an annular body and an annular support.

17. The cage system of claim 13, wherein the air exhauster couples to an air duct and the air exhauster exhausts air from within the cage into the air duct when the air exhauster is coupled to a power supply.

18. The cage system of claim 16, wherein the annular body includes a conical trunk region, the conical trunk region having a tubular protrusion that couples to an air duct.

19. The cage system of claim 16, wherein the annular support includes an orifice and a screen disposed within the orifice, the orifice coincident with the air outlet opening disposed in the cage body.

20. A cage system, the system comprising:
a cage having a cage body and a lid coupled to the cage body, the lid including at least one air inlet opening and the cage body including at least one air outlet opening; and
an exhaust system coupled to the cage, the exhaust system including an air exhauster coupled to the air outlet opening of the cage body and a filter coupled to the air inlet opening of the lid, the air exhauster exhausting air from within the cage and creating a negative pressure that draws air into the cage through the air inlet opening and filter of the lid when the air exhauster is coupled to a power source.
